(19) United States
(12) Patent Application Publication
(10) Pub. No.: US 2026/0282077 A1
(43) Pub. Date: Sep. 17, 2026

(54) METHODS, SYSTEMS, AND APPARATUSES FOR MULTI-ACCESS POINT COORDINATION

(71) Applicant: NOKIA TECHNOLOGIES OY, Espoo (FI)

(72) Inventors: Mika Kasslin, Espoo (FI); Orhan Okan Mutgan, Munich (DE); Salvatore Talarico, Sunnyvale, CA (US); Prabodh Varshney, Irving, TX (US)

(21) Appl. No.: 19/077,183

(22) Filed: Mar. 12, 2025

(51) Int. Cl. H04W 74/08; H04W 48/08

(52) U.S. Cl. CPC H04W 74/08; H04W 48/08

(57) ABSTRACT

Methods, apparatuses, and systems provide for multi-access point (multi-AP) coordination. In the context of a method, the method includes receiving a physical layer protocol data unit (PPDU) or a primitive associated with the PPDU on a primary channel of a first basic service set (BSS) associated with an apparatus, wherein the PPDU or the primitive is received from a second BSS; and performing one or more operations based at least in part on a PPDU class associated with the PPDU, wherein the PPDU class pertains to multi-AP coordination between the first BSS and the second BSS.

### TECHNOLOGICAL FIELD

Various aspects of the present disclosure relate generally to techniques for non-primary channel access (NPCA) and, more particularly, to a framework for simultaneous use of NPCA and multi-AP coordination schemes.

### BACKGROUND

Wireless communications systems, such as wireless fidelity (Wi-Fi) systems, may support non-primary channel access (NPCA) for Wi-Fi stations (STAs). In accordance with some NPCA designs, STAs may switch to an NPCA primary channel in response to a set of conditions being satisfied. In some cases, the set of conditions used by a STA for determining whether to switch to the NPCA primary channel may reduce resource utilization within the Wi-Fi system and constrain a performance of latency-sensitive applications at the STA.

### BRIEF SUMMARY

Methods, apparatuses, and systems are disclosed for multi-access point coordination. In this regard, the methods, apparatuses, and systems are configured to support a framework for simultaneous use of NPCA and multi-AP coordination. For example, the methods, apparatuses, and systems are configured to support joint operation of NPCA and one or more multi-AP coordination schemes. By providing for simultaneous use of NPCA and multi-AP coordination, the methods, apparatuses, and systems may reduce latency and improve resource utilization within a wireless communications system.

In at least one example embodiment, an apparatus is provided comprising at least one processor and at least one memory storing instructions that, when executed by the at least one processor, cause the apparatus at least to: receive a physical layer protocol data unit (PPDU) or a primitive associated with the PPDU; and classify the PPDU based at least in part on information included in the PPDU or the primitive, wherein classification of the PPDU comprises selecting a PPDU class for the PPDU from among a plurality of PPDU classes pertaining to multi-access point (multi-AP) coordination with a first basic service set (BSS) associated with the apparatus.

In at least one example embodiment, selecting the PPDU class comprises: selecting a first PPDU class of the plurality of PPDU classes based at least in part on the PPDU or the primitive being received from a BSS with which the first BSS has a multi-AP coordination agreement or at least one active multi-AP coordination scheme; or selecting a second PPDU class of the plurality of PPDU classes based at least in part on the PPDU or the primitive being received from a BSS with which the first BSS has no multi-AP coordination agreement or no active multi-AP coordination scheme.

In at least one example embodiment, the information is indicative of at least one of the following: a BSS identifier (ID) or a BSS color.

In at least one example embodiment, the PPDU or the primitive carries a frame that has a BSS ID field indicating a value of a BSS ID, and wherein selecting the PPDU class comprises: selecting a first PPDU class of the plurality of PPDU classes for the PPDU based at least in part on at least one of the following: the BSS ID corresponds to one of a set of BSSs with which the first BSS has a multi-AP coordination agreement, or the BSS ID corresponds to one of a set of BSSs with which the first BSS has at least one active multi-AP coordination scheme.

In at least one example embodiment, the PPDU or the primitive carries a BSS color parameter field indicating a value of a BSS color, and wherein selecting the PPDU class comprises: selecting a first PPDU class of the plurality of PPDU classes for the PPDU based at least in part on at least one of the following: the BSS color is associated with one of a set of BSSs with which the first BSS has a multi-AP coordination agreement, the BSS color is associated with one of a set of BSSs with which the first BSS has at least one active multi-AP coordination scheme, or the BSS color is associated with the first BSS.

In at least one example embodiment, the first PPDU class comprises a multi-AP coordination (MAPC) PPDU class representative of PPDUs which a station (STA) of a BSS receives from another BSS with which the BSS has a multi-AP coordination agreement and at least one multi-AP coordination scheme in use.

In at least one example embodiment, the PPDU or the primitive carries a frame that has a BSS ID field indicating a value of a BSS ID, and wherein selecting the PPDU class comprises: selecting a second PPDU class of the plurality of PPDU classes for the PPDU based at least in part on at least one of the following: the BSS ID corresponds to a BSS outside of a set of BSSs with which the first BSS has a multi-AP coordination agreement, or the BSS ID corresponds to a BSS outside of a set of BSSs with which the first BSS has at least one active multi-AP coordination scheme.

In at least one example embodiment, the PPDU or the primitive carries a BSS color parameter field indicating a value of a BSS color, and wherein selecting the PPDU class comprises: selecting a second PPDU class of the plurality of PPDU classes for the PPDU based at least in part on at least one of the following: the BSS color is associated with a BSS outside of a set of BSSs with which the first BSS has a multi-AP coordination agreement, the BSS color is associated with a BSS outside of a set of BSSs with which the first BSS has at least one active multi-AP coordination scheme, or the BSS color is different from another BSS color associated with the first BSS.

In at least one example embodiment, the second PPDU class comprises a non-MAPC PPDU class representative of PPDUs which a station (STA) of a BSS receives from another BSS with which the BSS has no multi-AP coordination agreement or no multi-AP coordination scheme in use.

In at least one example embodiment, the PPDU comprises one of the following: a high efficiency (HE) PPDU, an extremely high throughput (EHT) PPDU, or an ultra high reliability (UHR) PPDU.

In at least one example embodiment, the primitive is associated with the PPDU by being indicative of an incoming frame carried in the PPDU.

In at least one example embodiment, the primitive comprises a PHY-RXSTART.indication primitive.

In at least one example embodiment, the apparatus comprises an AP or non-access point (non-AP) station (STA).

In at least one example embodiment, the AP or non-AP STA is capable of performing one or more NPCA operations.

In at least one example embodiment, a method is provided comprising: receiving a physical layer protocol data unit (PPDU) or a primitive associated with the PPDU; and classifying the PPDU based at least in part on information included in the PPDU or the primitive, wherein classification of the PPDU comprises selecting a PPDU class for the PPDU from among a plurality of PPDU classes pertaining to multi-access point (multi-AP) coordination with a first basic service set (BSS) associated with an apparatus.

In at least one example embodiment, a non-transitory computer readable storage medium is provided. The non-transitory computer readable storage medium comprises computer instructions that, when executed by an apparatus, cause the apparatus at least to: receive a physical layer protocol data unit (PPDU) or a primitive associated with the PPDU; and classify the PPDU based at least in part on information included in the PPDU or the primitive, wherein classification of the PPDU comprises selecting a PPDU class for the PPDU from among a plurality of PPDU classes pertaining to multi-access point (multi-AP) coordination with a first basic service set (BSS) associated with the apparatus.

In at least one example embodiment, an apparatus is provided that comprises means for: receiving a physical layer protocol data unit (PPDU) or a primitive associated with the PPDU; and classifying the PPDU based at least in part on information included in the PPDU or the primitive, wherein classification of the PPDU comprises selecting a PPDU class for the PPDU from among a plurality of PPDU classes pertaining to multi-access point (multi-AP) coordination with a first basic service set (BSS) associated with an apparatus.

In at least one example embodiment, an apparatus is provided comprising at least one processor and at least one memory storing instructions that, when executed by the at least one processor, cause the apparatus at least to: receive a physical layer protocol data unit (PPDU) or a primitive associated with the PPDU on a primary channel of a first basic service set (BSS) associated with the apparatus, wherein the PPDU or the primitive is received from a second BSS; and perform one or more operations based at least in part on a PPDU class associated with the PPDU, wherein the PPDU class pertains to multi-access point (multi-AP) coordination between the first BSS and the second BSS.

In at least one example embodiment, performing the one or more operations comprises: switching from the primary channel to a non-primary channel access (NPCA) primary channel for NPCA operations based at least in part on the PPDU class.

In at least one example embodiment, switching to the NPCA primary channel is based at least in part on the PPDU class comprising a non-multi-AP coordination (non-MAPC) PPDU class representative of PPDUs which a station (STA) of a BSS receives from another BSS with which the BSS has no multi-AP coordination agreement or no multi-AP coordination scheme in use.

In at least one example embodiment, the one or more operations are associated with a multi-AP coordination scheme, and wherein the one or more operations are performed in accordance with a multi-AP coordination agreement between the first BSS and the second BSS.

In at least one example embodiment, the multi-AP coordination scheme comprises one of the following: coordinated beamforming (Co-BF), coordinated spatial reuse (Co-SR), coordinated restricted target wake time (Co-RTWT), or coordinated time division multiple access (Co-TDMA).

In at least one example embodiment, the instructions, when executed by the at least one processor, cause the apparatus at least to: switch from the primary channel to a non-primary channel access (NPCA) primary channel for NPCA operations after completion of the one or more operations.

In at least one example embodiment, performing the one or more operations is based at least in part on the PPDU class comprising a multi-AP coordination (MAPC) PPDU class representative of PPDUs which a station (STA) of a BSS receives from another BSS with which the BSS has a multi-AP coordination agreement and at least one multi-AP coordination scheme in use.

In at least one example embodiment, the PPDU comprises one of the following: a high efficiency (HE) PPDU, an extremely high throughput (EHT) PPDU, or an ultra high reliability (UHR) PPDU.

In at least one example embodiment, the primitive is associated with the PPDU by being indicative of an incoming frame carried in the PPDU.

In at least one example embodiment, the primitive comprises a PHY-RXSTART.indication primitive.

In at least one example embodiment, the apparatus comprises an AP or non-access point (non-AP) station (STA).

In at least one example embodiment, the AP or non-AP STA is capable of performing one or more NPCA operations.

In at least one example embodiment, a method is provided comprising: receiving a physical layer protocol data unit (PPDU) or a primitive associated with the PPDU on a primary channel of a first basic service set (BSS) associated with an apparatus, wherein the PPDU or the primitive is received from a second BSS; and performing one or more operations based at least in part on a PPDU class associated with the PPDU, wherein the PPDU class pertains to multi-access point (multi-AP) coordination between the first BSS and the second BSS.

In at least one example embodiment, a non-transitory computer readable storage medium is provided. The non-transitory computer readable storage medium comprises computer instructions that, when executed by an apparatus, cause the apparatus at least to: receive a physical layer protocol data unit (PPDU) or a primitive associated with the PPDU on a primary channel of a first basic service set (BSS) associated with the apparatus, wherein the PPDU or the primitive is received from a second BSS; and perform one or more operations based at least in part on a PPDU class associated with the PPDU, wherein the PPDU class pertains to multi-access point (multi-AP) coordination between the first BSS and the second BSS.

In at least one example embodiment, an apparatus is provided that comprises means for: receiving a physical layer protocol data unit (PPDU) or a primitive associated with the PPDU on a primary channel of a first basic service set (BSS) associated with an apparatus, wherein the PPDU or the primitive is received from a second BSS; and performing one or more operations based at least in part on a PPDU class associated with the PPDU, wherein the PPDU class pertains to multi-access point (multi-AP) coordination between the first BSS and the second BSS.

In at least one example embodiment, an apparatus is provided comprising at least one processor and at least one memory storing instructions that, when executed by the at least one processor, cause the apparatus at least to: receive a message comprising information associated with one or more multi-access point (multi-AP) coordination relationships between a first basic service set (BSS) including the apparatus and one or more other BSSs; receive a physical layer protocol data unit (PPDU) or a primitive associated with the PPDU on a primary channel of the first BSS; and determine a PPDU class for the PPDU based at least in part on the information.

In at least one example embodiment, the instructions, when executed by the at least one processor, cause the apparatus at least to: receive a second message comprising second information associated with the one or more multi-AP coordination relationships, wherein the second information indicates a change to the one or more multi-AP coordination relationships.

In at least one example embodiment, the information comprises at least one of the following: at least one BSS identifier (ID) associated with the one or more other BSSs, at least one BSS color associated with the one or more other BSSs, a status of at least one multi-AP coordination (MAPC) negotiation with the one or more other BSSs, or at least one coordination scheme negotiated for use between the first BSS and the one or more other BSSs.

In at least one example embodiment, receiving the message comprises: receiving an association response frame or beacon frame including the information.

In at least one example embodiment, receiving the message comprises: receiving an action frame including the information, wherein the action frame is unicast action, multicast, or broadcast from an access point (AP).

In at least one example embodiment, the PPDU comprises one of the following: a high efficiency (HE) PPDU, an extremely high throughput (EHT) PPDU, or an ultra high reliability (UHR) PPDU.

In at least one example embodiment, the primitive is associated with the PPDU by being indicative of an incoming frame carried in the PPDU.

In at least one example embodiment, the primitive comprises a PHY-RXSTART.indication primitive.

In at least one example embodiment, the apparatus comprises a non-access point (non-AP) station (STA).

In at least one example embodiment, the non-AP STA is capable of performing one or more NPCA operations.

In at least one example embodiment, an apparatus is provided comprising at least one processor and at least one memory storing instructions that, when executed by the at least one processor, cause the apparatus at least to: establish one or more one or more multi-access point (multi-AP) coordination relationships between a first basic service set (BSS) including the apparatus and one or more other BSSs; and transmit, to a non-access point (non-AP) station (STA), a message comprising information associated with the one or more multi-AP coordination relationships.

In at least one example embodiment, the instructions, when executed by the at least one processor, cause the apparatus at least to: identify a change to the one or more multi-AP coordination relationships; and transmit a second message to the non-AP STA in response to identifying the change, wherein the second message comprises second information that is indicative of the change.

In at least one example embodiment, the information pertains to classification of physical layer protocol data units (PPDUs) at the non-AP STA.

In at least one example embodiment, the PPDUs comprise one of the following: high efficiency (HE) PPDUs, extremely high throughput (EHT) PPDUs, or ultra high reliability (UHR) PPDUs.

In at least one example embodiment, the information comprises at least one of the following: at least one BSS identifier (ID) associated with the one or more other BSSs, at least one BSS color associated with the one or more other BSSs, a status of at least one multi-AP coordination (MAPC) negotiation with the one or more other BSSs, or at least one coordination scheme negotiated for use between the first BSS and the one or more other BSSs.

In at least one example embodiment, the apparatus comprises an access point (AP).

In at least one example embodiment, the AP is capable of performing one or more NPCA operations.

In at least one example embodiment, a method is provided comprising: receiving a message comprising information associated with one or more multi-access point (multi-AP) coordination relationships between a first basic service set (BSS) including an apparatus and one or more other BSSs; receiving a physical layer protocol data unit (PPDU) or a primitive associated with the PPDU on a primary channel of the first BSS; and determining a PPDU class for the PPDU based at least in part on the information.

In at least one example embodiment, a method is provided comprising: establishing one or more one or more multi-access point (multi-AP) coordination relationships between a first basic service set (BSS) including an apparatus and one or more other BSSs; and transmitting, to a non-access point (non-AP) station (STA), a message comprising information associated with the one or more multi-AP coordination relationships.

In at least one example embodiment, a non-transitory computer readable storage medium is provided. The non-transitory computer readable storage medium comprises computer instructions that, when executed by an apparatus, cause the apparatus at least to: receive a message comprising information associated with one or more multi-access point (multi-AP) coordination relationships between a first basic service set (BSS) including the apparatus and one or more other BSSs; receive a physical layer protocol data unit (PPDU) or a primitive associated with the PPDU on a primary channel of the first BSS; and determine a PPDU class for the PPDU based at least in part on the information.

In at least one example embodiment, a non-transitory computer readable storage medium is provided. The non-transitory computer readable storage medium comprises computer instructions that, when executed by an apparatus, cause the apparatus at least to: establish one or more one or more multi-access point (multi-AP) coordination relationships between a first basic service set (BSS) including the apparatus and one or more other BSSs; and transmit, to a non-access point (non-AP) station (STA), a message comprising information associated with the one or more multi-AP coordination relationships.

In at least one example embodiment, an apparatus is provided that comprises means for: receiving a message comprising information associated with one or more multi-access point (multi-AP) coordination relationships between a first basic service set (BSS) including an apparatus and one or more other BSSs; receiving a physical layer protocol data unit (PPDU) or a primitive associated with the PPDU on a primary channel of the first BSS; and determining a PPDU class for the PPDU based at least in part on the information.

In at least one example embodiment, an apparatus is provided that comprises means for: establishing one or more one or more multi-access point (multi-AP) coordination relationships between a first basic service set (BSS) including an apparatus and one or more other BSSs; and transmitting, to a non-access point (non-AP) station (STA), a message comprising information associated with the one or more multi-AP coordination relationships.

The above summary is provided merely for purposes of summarizing at least some example embodiments to provide a basic understanding of some aspects of the disclosure.

Accordingly, it will be appreciated that the above-described embodiments are merely examples and should not be construed to narrow the scope of the disclosure in any way. It will also be appreciated that the scope of the disclosure encompasses many potential embodiments in addition to those summarized here, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example communications system to which one or more examples disclosed herein may be applied;

FIG. 2A illustrates an example communications system to which one or more examples disclosed herein may be applied;

FIGS. 2B and 2C illustrate example timing diagrams to which one or more examples disclosed herein may be applied;

FIGS. 3 through 5 illustrate example signaling diagrams to which one or more examples disclosed herein may be applied;

FIG. 6 illustrates an example block diagram of an apparatus to which one or more examples disclosed herein may be applied; and

FIG. 7 illustrates an example flowchart of a method to which one or more examples disclosed herein may be applied.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a communications system (e.g., a communication network), such as any of the following radio access technologies (RATs): wireless fidelity (Wi-Fi), BLUETOOTH, Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunications system (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future radio access technology (RAT) such as 6G. Moreover, communication within the communication network may utilize any suitable wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiplexing (OFDM), and/or Discrete Fourier Transform spread OFDM (DFT-s-OFDM).

The term “terminal device” refers to any end device that may be capable of wireless communication. By way of example, a terminal device may be referred to as a communication device, user equipment (UE), a Subscriber Station (SS), a Mobile Station (MS). The terminal device may include a mobile phone, a cellular phone, a smart phone, voice over IP (VOIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, universal serial bus (USB) USB dongles, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

In some examples, a communications system may be deployed in a wireless local area network (WLAN), such as a Wi-Fi network. That is, in some examples, a communications system may be an example of a WLAN system. The WLAN system may support wireless communications between one or more communications devices in accordance with one or more Wi-Fi protocols, such as protocols based on institute of electrical and electronics engineers (IEEE) 802.11 standards and/or related drafts, such as 802.11-2020, 802.11ac, 802.11ax, 802.11be, 802.11bn, and/or others.

In some examples, Wi-Fi communications may occur via one or more radio frequency bands, such as 2.4 gigahertz (GHz), 3.6 GHz, 5 GHz, 6 GHz, 60 GHz, and/or the like. In some such examples, each radio frequency band may support one or more channels (e.g., 20 megahertz (MHz) channels) over which data may be communicated. In some examples, multiple devices may use multiple channels to communicate over the WLAN simultaneously.

A WLAN system may include one or more communications devices, which are referred to herein as stations (STAs). A STA may be an access point (AP) and/or a non-AP STA. For example, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. As such, a non-AP STA may also be referred to as a client. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID) or a basic service set identifier (BSSID).

In some examples, an AP of a WLAN system includes at least one distribution system access function configured to facilitate data communication beyond the AP. Additionally, or alternatively, non-AP STAs may be configured to be end devices, which rely on association with an AP to communicate with devices other than the AP. An AP may be configured to connect to a wired local area network (LAN) (e.g., via Ethernet). The AP may allow one or more client devices (e.g., non-AP STAs) to access wireless connections via WLAN. The client devices may also be referred to as “WLAN clients”. WLAN clients may comprise various devices and/or types of devices, including laptops, tablets, cell phones, and/or other devices.

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity, which may be configured to act as a network manager. In some examples, the network manager is a cloud-based entity, which may reside either in a private cloud or in a public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients. For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more clients may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more clients, may communicate wirelessly with one or more other APs.

In accordance with one or more Wi-Fi protocols, data may be transmitted wirelessly between two devices (e.g., an AP and a client) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDU, wherein a payload of a PDU may comprise user data, control data, management data, and/or other data. In some examples, a WLAN system may implement one or more security protocols to protect the confidentiality, integrity, and availability of Wi-Fi communications.

In some examples, a WLAN system may support transmission opportunities (TXOPs) to increase throughput, such as for high priority data, by providing contention-free channel access for a period of time. A TXOP may be available in a quality of service (QOS) mode as part of Enhanced Distributed Channel Access (EDCA), and/or may be a limited time period of contention-free channel access available to the channel-owning station (e.g., the TXOP holder). During such a period a TXOP holder, which may be a non-AP STA or an AP, may send multiple frames that satisfy criteria, which may have been determined for the use of TXOP. In some examples, the criteria may allow transmission of frames belonging to an access category (AC) other than the AC for which the TXOP has been obtained. In some examples, a TXOP may increase throughput and/or reduce delay of QoS data frames by eliminating contention periods between transmissions. In some examples, a TXOP may be used in combination with frame aggregation and block acknowledgement to further increase throughput.

In some examples, access categories have different channel access parameters, such as Arbitration Interframe Spacing (AIFS), duration, contention window size, and TXOP limit. In some examples, values of these parameters may be set in a manner that increases a likelihood of higher priority packets being prioritized over lower priority packets. For example, the values of the parameters may be set that a non-AP STA (typically) waits for a shorter duration before sending the higher priority packets compared to a duration that the non-AP STA may wait before sending the lower priority packets. Additionally, or alternatively, the values of the parameters may be set so that the contention window for higher priority packets is smaller than that of lower priority packets and/or so that multiple packets may be sent in a TXOP. In some examples, a TXOP holder, which may be either a non-AP STA or an AP, may send frames to multiple recipients during a TXOP. In addition to QoS data frames, other frames may be exchanged during the TXOP, such as an acknowledgement (ACK), BlockAckReq/BlockAck frames, and/or other control and management frames.

In some examples, a WLAN system uses multi-link operation (MLO) to improve data transmission (e.g., via using multiple frequency bands for transmissions). In some examples, MLO further comprises various features, including simultaneous transmit and receive (STR), multi-channel multi-radio (MCMR), enhanced multi-AP roaming (E-MAR), non-simultaneous transmit and receive (NSTR), multi-link multi-radio (MLMR), and/or other features.

An AP that supports MLO may be referred to as an AP multi-link device (MLD). An MLO-capable client, for example, such as a non-AP STA, may be referred to as a non-AP MLD. Such a client device may have two or more non-AP STAs with which it may establish links to an AP MLD. A connection between a non-AP STA and AP may represent a link between an AP MLD and a non-AP MLD. In some examples, APs which do not support MLO may be multi-band APs which have two or more APs operating in different bands and/or channels. An AP may operate in one or more bands and/or channels and a client device may connect to the AP via one or more of the bands and/or channels. For example, a client device may associate with the AP in one of the channels. An AP MLD may operate as a multi-band AP, while providing means for a multi-link capable client (non-AP MLD) to simultaneously use two or more of its radios and/or APs for communication with a single association. An AP MLD may be an MLMR, which is configured to communicate simultaneously with its APs with associated non-AP MLDs. Non-AP MLDs may have constraints (e.g., NSTR), which may indicate that simultaneous communication over established links is not possible. Therefore, in some such instances, a non-AP MLD may associate to an AP MLD. Accordingly, the non-AP MLD may be associated over two or more bands and/or channels and may communicate with the APs affiliated to the AP MLD over the established links.

WLAN devices configured with STR may be configured to allow simultaneous transmission and/or reception via different respective frequency bands, which may reduce latency. WLAN devices configured with MCMR may be configured to allow data transmission via two or more radios and/or channels, which may increase efficiency, reduce congestion, and/or increase network speeds. WLAN devices configured with enhanced multilink single-radio (EMLSR) may be configured to allow client devices to switch between multiple respective APs while maintaining their connections, which may allow more consistent connectivity. WLAN devices configured with NSTR may be configured to allow client devices to non-simultaneous transmission and/or reception via different respective frequency bands, which may reduce latency (particularly in comparison with single-link operation). WLAN devices configured with MLMR may be configured to allow different respective radios and/or channels to be used for managing respective links, which may reduce interference and/or improve network performance.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common physical layer (PHY) medium access characteristics (e.g., radio frequency, modulation scheme, security settings, and/or the like). A BSSID may define the BSS such that the one or more client devices of the BSS share the same BSSID.

In some examples, two or more BSSs may have overlapping coverage areas, and they may operate with either partially or entirely same radio frequency channels. In such examples of overlapping BSSs (OBSSs), a client device may transmit frames from the area of overlap, and one or more other client devices may sense the transmission. Responsive to sensing the transmission, the one or more other client devices may cease their own transmissions. In some examples, if the other client devices do not sense the transmission, the other client devices may become hidden terminals with respect to the client device which is transmitting.

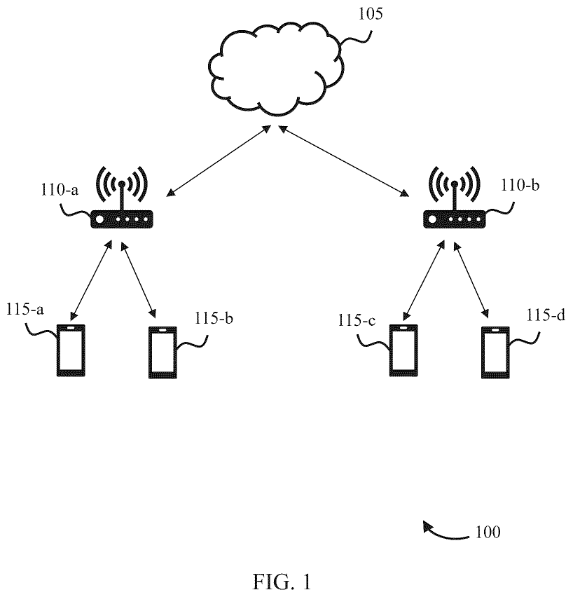

FIG. 1 illustrates an example communications system 100 to which one or more examples disclosed herein may be applied. The communications system 100 may include a cloud network 105, one or more APs (e.g., an AP 110-a, an AP 110-b), and one or more client devices connected to the one or more APs. A client device is also referred to herein as a non-AP STA. The communications system 100 may include a client 115-a and a client 115-b connected to the AP 110-a, as well as a client 115-c and a client 115-d connected to the AP 110-b. In some examples, the APs 110 may be mobile access points (mAPs) with constrained functionality. In some such examples, a configuration comprising an mAP and a client may be implemented as part of a peer-to-peer connection, for example, as in Wi-Fi Direct or Wi-Fi Aware. In some examples, a device may simultaneously operate as a client and as an AP. One such an example case is in a multi-AP network, which includes two or more devices that may act as APs and use Wi-Fi for the wireless backhaul connectivity based on a client-AP connection model.

In some wireless communications systems, APs may provide wireless connectivity for one or more clients according to the Wi-Fi standards, such as those that are a subset of the IEEE 802 family of standards. For example, the MAC and PHY specifications for Wi-Fi access points are defined by IEEE 802.11 for transmitting and receiving data in frequency bands such as 2.4 GHz, 3.6 GHz, 5 GHz, 6 GHz, 60 GHz, and/or the like. APs and clients may communicate through the transmission of frames, including data frames, management frames, and/or control frames, which may be transmitted in unicast messages, broadcast messages, or multicast messages. The 802.11 standards define an inter-frame space (IFS) as the nominal time (in microseconds (us)) that the MAC and PHY use to receive the last symbol of a frame, process the frame, and respond with the first symbol of a response frame (e.g., the earliest possible response frame).

In the example of FIG. 1, the clients 115 may be configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, UEs, and/or other entities suitable for such usage. For example, the communications system 100 may support radio frequency sensing during IFS.

The communications system 100 may support a framework for simultaneous use of NPCA and multi-AP coordination schemes, in accordance with one or more aspects of the present disclosure. The framework may provide a means for a STA (e.g., an NPCA AP STA or an NPCA non-AP STA) which belongs to an NPCA enabled BSS to determine whether a received physical layer protocol data unit (PPDU) is from a BSS with which the NPCA enabled BSS has no multi-AP coordination agreement in place and/or no multi-AP coordination scheme in use, or is from another BSS with which the NPCA enabled BSS has a multi-AP coordination agreement in place and/or with which the AP of the NPCA enabled BSS uses one or more of the multi-AP coordination schemes. In other words, the framework may enable the STA to classify the received PPDU as a multi-AP coordination (MAPC) PPDU or a non-MAPC PPDU. The MAPC PPDU class represents PPDUs an NPCA STA receives from another BSS with which the BSS of the NPCA STA has multi-AP coordination agreement and/or at least one multi-AP coordination scheme in use. The non-MAPC PPDU class represents PPDUs an NPCA STA receives from another BSS with which the BSS of the NPCA STA has no multi-AP coordination agreement and/or no multi-AP coordination scheme in use. In some examples, in accordance with the framework, the STA may determine to perform one or more actions based on the classification of the PPDU. For example, if the PPDU is from an AP (or a BSS) with which the NPCA enabled BSS has no multi-AP coordination agreement in place and/or no multi-AP coordination scheme in use (e.g., if the STA classifies the PPDU as a non-MAPC PPDU), the STA may directly proceed to consider switching to the NPCA primary channel. Alternatively, if the PPDU is from an AP (or a BSS) with which the NPCA enabled BSS has a multi-AP coordination agreement in place and at least one multi-AP coordination scheme in use (e.g., if the STA classifies the PPDU as a MAPC PPDU), the STA may act according to the rules specified for the multi-AP coordination scheme applied to the TXOP. By enabling the STA to classify the PPDU as a MAPC PPDU or a non-MAPC PPDU, the STA may improve resource utilization and reduce latency within the communications system 100.

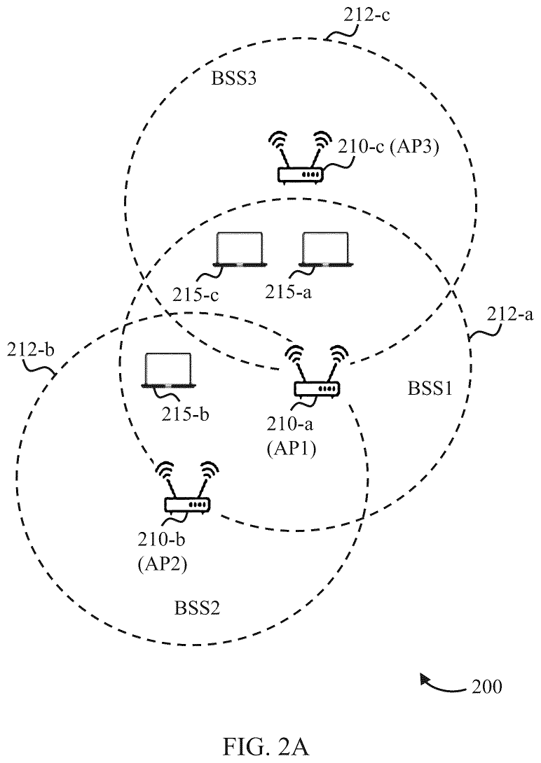

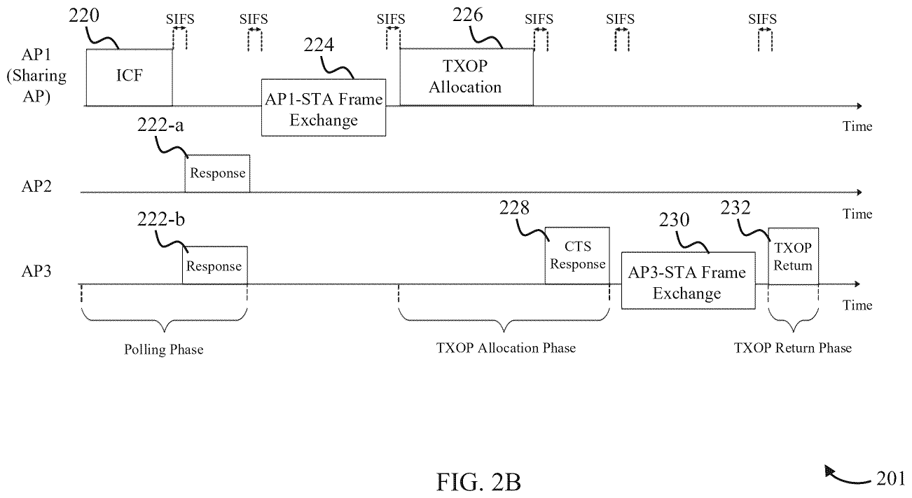

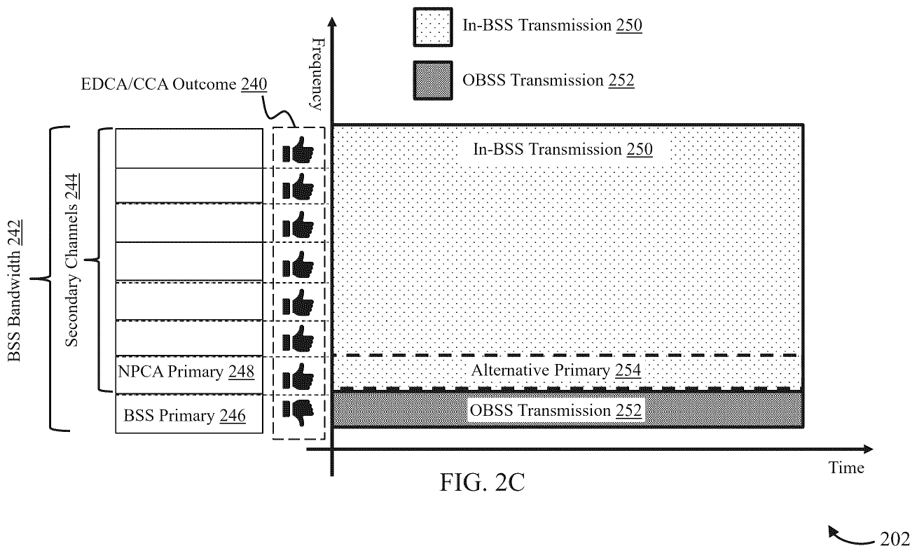

FIG. 2A illustrates an example communications system 200 to which one or more examples disclosed herein may be applied. The communications system 200 may be an example of a communications system illustrated by and described with reference to FIG. 1. For example, the communications system 200 may include APs 210, and clients 215 (e.g., non-AP STAs) connected to the APs 210. As illustrated in the example of FIG. 2A, the communications system 200 may include an AP 210-a (AP1) providing a coverage area 212-a, an AP 210-b (AP2) providing a coverage area 212-b, and an AP 210-c (AP3) providing a coverage area 212-c. The APs 210 may be examples of an AP illustrated by and described with reference to FIG. 1. The communications system 200 also includes a client 215-a, a client 215-b, and a client 215-c. The clients 215 may be examples of a STA (e.g., a non-AP STA) illustrated by and described with reference to FIG. 1. In the example of FIG. 2A, the AP 210-a may be connected to the client 215-a (e.g., the AP 210-a and the client 215-a may be included in BSS1), the AP 210-b may be connected to the client 215-b (e.g., the AP 210-b and the client 215-b may be included in BSS2), and the AP 210-c may be connected to the client 215-c (e.g., the AP 210-c and the client 215-c may be included in BSS3).

In some examples, the communications system 200 may support one or more multi-AP coordination schemes including. For example, the communications system 200 may support coordinated beamforming (Co-BF), coordinated spatial reuse (Co-SR), coordinated RTWT (Co-RTWT), and coordinated time division multiple access (Co-TDMA). In multi-AP coordination schemes (e.g., Co-BF, Co-SR, Co-RTWT, and Co-TDMA), two or more APs may share a TXOP. For example, an AP (referred to as a sharing AP) that has obtained a TXOP may share the TXOP with one or more other APs (referred to as shared APs). In the example of FIG. 2A, the AP 210-a (AP1) may be an example of a sharing AP, while the AP 210-b (AP2) and the AP 210-c (AP3) may be examples of a shared AP.

With the Co-BF multi-AP coordination scheme, two APs (a sharing AP and a shared AP) may transmit simultaneously to non-AP STAs by using beamforming across BSSs to place nulls to selected non-AP STAs in the other BSS. For example, the shared AP may transmit across both the BSS of the shared AP and the BSS of the sharing AP, and may use beamforming to place nulls to non-AP STAs in the BSS of the sharing AP. Simultaneously, the sharing AP may transmit across both the BSS of the sharing AP and the BSS of the shared AP, and may use beamforming to place nulls to non-AP STAs in the BSS of the shared AP. As illustrated in the example of FIG. 2A, the AP 210-a may share a TXOP with AP 210-b. In such an example, using Co-BF, AP 210-a (e.g., the sharing AP) may transmit across both BSS1 and BSS2, and may use beamforming to place nulls to the client 215-b. Simultaneously, AP 210-b (e.g., the sharing AP) may transmit across both BSS1 and BSS2, and may use beamforming to place nulls to the client 215-a.

With the Co-SR multi-AP coordination scheme, two (or more) APs may transmit simultaneously at the TXOP level to associated non-AP STAs by constraining the transmit power used by the APs within a shared portion of the TXOP to one or more levels, which allows simultaneous communication in the two (or more) BSSs. With the Co-RTWT multi-AP coordination scheme, two coordinating APs (e.g., AP 210-a and 210-b) may negotiate their schedules so as to avoid overlapping transmissions within the overlapping part of two service periods. For example, an AP may ensure its TXOP ends before the start time of one or more corresponding OBSS rTWT service periods. With the Co-TDMA multi-AP coordination scheme, a shared AP may be given an opportunity by a sharing AP to communicate with associated non-AP STAs during a part of the TXOP obtained by the shared AP.

In one or more multi-AP coordination schemes, the AP that has obtained a TXOP has an opportunity to approach one or more other APs with which the AP has agreed to use at least one of the multi-AP coordination schemes. For example, the AP 210-a may have a multi-AP coordination agreement with AP 210-b. In such an example, AP 210-a may obtain a TXOP and may offer AP 210-b an opportunity to use at least a portion of the TXOP in accordance with at least one of the multi-AP coordination schemes covered by the multi-AP coordination agreement.

In some examples, the AP that has obtained a TXOP may indicate to those one or more APs that the TXOP is available for joint use per one or more scheme specific rules and conditions. According to some multi-AP coordination designs, the AP with the TXOP may transmit an initial control frame (ICF) which may be, as an example, a trigger frame (e.g., BSRP, multi-user request to send (MU-RTS)). The ICF may include an identifier of the AP (e.g., a user info field and AID12 subfield), which is proposed to become the shared AP. The ICF may include one or more other identifiers. For example, the ICF may include identifiers of the non-AP STAs connected to the sharing AP and an identifier of the multi-AP coordination scheme proposed for the TXOP. Once a proposed shared AP receives the ICF, the proposed shared AP may be provided with a means to either accept the proposal or decline the proposal. In some instances, the proposed shared AP may (e.g., is expected to) respond to the ICF indicating, as an example, whether the proposal is accepted or not. In some of the multi-AP coordination schemes, no response from the proposed shared AP is not expected (or even possible). There might be, as an example, an implicit or explicit agreement between the two APs that whenever one of the APs receives an ICF from the other AP, the APs use one of the agreed multi-AP coordination schemes for the TXOP.

FIG. 2B illustrates an example timing diagram 201 to which one or more examples disclosed herein may be applied. The example timing diagram 201 illustrates an exemplary case of co-TDMA. Although the operations illustrated in the example of FIG. 2B are illustrated in the context of co-TDMA, one or more of the operations may be applicable to one or more other multi-AP coordination schemes. The timing diagram 202 may be implemented at the APs 210 (e.g., AP1, AP2, and AP3) illustrated by and described with reference to FIG. 2A. As illustrated in the example of FIG. 2B, AP1 may be an example of a sharing AP. For example, at 220, during a polling phase, AP1 may transmit an ICF to AP2 and AP3. In response to the ICF, AP2 and AP3 may transmit a response to AP1 at 222-a and 222-b, respectively. At 224, AP1 may exchange one or more frames with one or more clients connected to AP1 (e.g., client 215-a). At 226, after the frame exchange(s) between AP1 and its client(s), AP1 may perform a TXOP allocation to AP3 using, for example, an MU-RTS TXS trigger frame. The TXOP allocation may occur during a TXOP allocation phase. At 228, during the TXOP allocation phase, AP3 may transmit a clear to send (CTS) response to AP1. At 230, AP3 may use a portion of the TXOP obtained (and shared) by AP1 to exchange one or more frames with a client of AP3 (e.g., client 115-c). At 232, after the frame exchange(s) between AP3 and its client(s), AP3 may return the TXOP to AP1 (e.g., during a TXOP return phase).

In some examples, the communications system 200 may support latency-sensitive applications at Wi-Fi devices (e.g., APs, non-AP STAs). Some such applications may include for example virtual reality (VR) applications, mixed reality (MR) applications, augmented reality (AR) applications, and extended reality (XR) applications. In some cases, reliability and non-deterministic channel access, such as for wideband transmissions, may constrain a performance of latency-sensitive applications. For example, for a wideband transmission (or channel bonding), a devices may use a primary 20 MHz channel to communicate control frames and management frames and may communicate data frames by bonding a BSS primary channel (also referred to herein as a reference primary channel or, more simply, a primary channel) with one or more other available 20 MHz channels, which are referred to as secondary channels. Channel bonding may provide for transmissions over multiple contiguous 20 MHz channels. In some instances, channel bonding may support transmissions over a total bandwidth of 40 MHz, 80 MHz, 160 MHz, or 320 MHz.

In some examples, if the device assesses the BSS primary channel to be idle, the device may perform a wideband transmission across a bandwidth including the BSS primary channel or the BSS primary channel and one or multiple contiguous secondary channels (e.g., totaling 40 MHz, 80 MHz, or 160 MHz or 320MHz). In some instances, however, an OBSS transmission may overlap (partially or fully) with the BSS primary channel. In some such instances, the device may determine that the BSS primary channel is busy and, as such, may defer the wideband transmission. Consequently, the secondary channels may sit idle until the BSS primary channel is available, which may lead to reduced performance, for example, for latency-sensitive applications.

Some wireless communications systems may employ one or more protocols to reduce latency for devices, such as STAs running latency-sensitive applications (e.g., VR, MR, AR, and/or XR applications). In some cases, however, a wireless communications system may experience constrained reliability and non-deterministic channel access, such as for wideband transmissions. For example, when a device uses wideband transmission (or channel bonding), the device may perform a listen-before-talk (LBT) procedure on each 20 MHz channel comprising the overall bandwidth used in the transmission. When operating in this mode, the device may select one of the 20 MHz channels as the primary channel. The selected channel may then be used as the primary channel (e.g., a reference primary channel) to communicate control frames (e.g., critical control frames) and management frames, as well as to support various types of STAs (e.g., legacy STAs, modern STAs), while data frames may be transmitted across the entire bandwidth (BW) by bonding the primary 20 MHz channel with other available channels (e.g., all other available 20 MHz channels), which are referred to herein as secondary channels. For a device, such as a STA (e.g., an AP or non-AP STA), to acquire a TXOP and perform a wideband transmission, the device first gains access to (e.g., “wins”) the primary channel via an Enhanced Distributed Channel Access (EDCA) procedure. The device may perform a separate check (e.g., via a point coordination function (PCF) interframe space (PIFS) Clear Channel Assessment (CCA)) to determine whether a secondary channel is idle. However, the device may perform the EDCA procedure to “win” the primary channel irrespective of whether one or more secondary channels are idle.

For example, the device (e.g., a STA) may adjust a transmission bandwidth of the STA per TXOP to include 20 MHz, 40 MHz, 80 MHz, or 160 MHz based on channel availability. In some examples, however, the adjustment to the transmission bandwidth may be contingent upon the resulting bandwidth being contiguous, and the primary channel being assessed to be idle. For example, the STA may adjust the transmission bandwidth of the STA per TXOP to include 20 MHz, 40 MHz, 80 MHz, or 160 MHz based on channel availability so long as the resulting bandwidth is contiguous, and the primary channel was assessed to be idle. In some cases, however, such constraints may result in a substantial amount of unused spectrum, as some non-contiguous 20 MHz channels may be available, but sit idle due to the STA being constrained to using contiguous channels and/or the primary channel being occupied. Given an increasing amount of spectrum available for wireless transmissions (e.g., 802.11 transmissions), necessitating that the STA first capture the primary channel may lead to relatively large portions of the spectrum going unused. Consequently, the primary channel may represent a bottleneck in terms of system performance and spectrum utilization.

Constraints caused from necessitating the device first gain access to the BSS primary channel, may increase a complexity associated with provisioning resource and assigning neighboring BSSs non-overlapping primary channels in Wi-Fi deployments. Additionally, in some instances, such constraints may preclude a device from having relatively high bandwidth support (as relatively high bandwidths may have an increased likelihood of overlapping a neighboring primary channel). Such constraints may therefore result is an inefficient use of the available spectrum resources and an ineffective system throughput. Moreover, constraints caused from necessitating the device first gain access to the BSS primary channel, may be exacerbated by increases in an operating bandwidth (e.g., a maximum operating bandwidth) with subsequent Wi-Fi generations.

To address these primary channel constraints, the communications system 200 may support non-primary channel access (NPCA), in which a Wi-Fi device may switch from a BSS primary channel to another alternative channel (referred to herein as an NPCA primary channel) for contention to obtain a TXOP when the device determines that the BSS primary channel occupied. NPCA allows the device to look for a TXOP by contending in the NPCA primary channel instead of waiting for the BSS primary channel to become available before resuming contention in the BSS primary channel.

FIG. 2C illustrates an example timing diagram 202 to which one or more examples disclosed herein may be applied. The timing diagram 202 may be implemented at the APs 210 (e.g., AP1, AP2, and AP3) and/or the clients 215 illustrated by and described with reference to FIG. 2A. For example, AP1 and client 215-a may be associated with a first BSS (BSS1) having a BSS bandwidth 242 (also referred to as reference bandwidth). The BSS bandwidth 242 may include multiple channels (e.g., multiple 20 MHz channels). To perform a wideband transmission using some (or all) of the BSS bandwidth 242, client 215-a may perform an LBT procedure (e.g., an EDCA or CCA procedure) on one or more of the 20 MHz channel. In some instances, one of the channels may be selected as a BSS primary channel, which is used by AP1 and client 215-a as the reference channel to communicate control frames and management frames between client 215-a and AP1. As illustrated in the example of FIG. 2B, a first 20 MHz channel (BSS primary channel 246) may be selected as the BSS primary channel. In some such examples, client 215-a may transmit data frames across multiple channels (e.g., the entire bandwidth) by bonding the BSS primary channel 246 with one or more other available secondary channels 244. In some examples, however, for client 215-a to acquire a TXOP and perform a wideband transmission, client 215-a may first gain access to the BSS primary channel 246 (e.g., via an EDCA procedure). That is, if client 215-a fails to capture the BSS primary channel 246, client 215-a may refrain from performing the wideband transmission irrespective of whether one or more secondary channels 244 are idle. In some instances, client 215-a may gain access to a channel (e.g., the BSS primary channel 246 and/or one or more of the secondary channels 244) via a PIFS CCA procedure. In other words, client 215-a may perform an EDCA and/or CCA procedure to gain access to one or more channels of the BSS bandwidth 242 for an In-BSS transmission 250. For example, if an EDCA/CCA outcome 240 for a channel is positive (illustrated with a thumbs-up icon), client 215-a may determine that the channel is available (e.g., idle). Additionally, if an EDCA/CCA outcome 240 for a channel is negative (illustrated with a thumbs-down icon), client 215-a may determine that the channel is unavailable (e.g., busy, occupied).

As illustrated in the example of FIG. 2C, the client 215-a may be NPCA capable. NPCA may enable client 215-a to temporarily utilize an alternative channel as a primary channel, referred to herein as an NPCA primary channel, when the BSS primary channel is occupied by an OBSS transmission or is otherwise unavailable. In other words, to increase spectrum utilization, a device (e.g., client 215-a, AP1) may be configured to support NPCA. For example, NPCA may enable the device to utilize a secondary channel as an NPCA primary channel for instances in which the BSS primary channel is occupied due to OBSS traffic or is otherwise unavailable. As illustrated in the example of FIG. 2C, an OBSS transmission 252 may occupy the BSS primary channel 246 and, as such, the client 215-a may use an NPCA primary channel 248 (e.g., one of the secondary channels 244) as an alternative primary channel 254 for an In-BSS transmission 250. The client 215-a may access a secondary channel when the BSS primary channel is known to be busy due to OBSS traffic or other conditions and determines that one of the secondary channels 244 is idle and may be used as the alternative primary channel 254.

In accordance with some NPCA designs, NPCA may be enabled by an AP (for the BSS of the AP). Additionally, once the NPCA is enabled for the BSS, the AP and NPCA capable non-AP STAs of the BSS may switch to the NPCA primary when one or more conditions are satisfied. For example, the AP and NPCA capable non-AP STAs of the BSS may switch to the NPCA primary when the STA receives a PPDU and/or a PHY-RXSTART.indication primitive for an HE/EHT/UHR PPDU on the BSS primary channel and all of the following conditions are true: (a) the PPDU is classified by the STA as an inter-BSS PPDU (e.g., following the procedure defined in 26.2.2 for intra-BSS and inter-BSS PPDU classification); (b) the duration of the PPDU, (determined by the MAC, but necessarily involving some of the parameters of the RXVECTOR associated with the received PPDU) or the duration of the PPDU plus the value of the RXVECTOR parameter TXOP_DURATION of the PPDU, is greater than the value indicated in the most recently received or transmitted NPCA minimum duration threshold field corresponding to the BSS of which it is a member (the RXVECTOR parameter TXOP_DURATION of the PPDU may be considered for this comparison and it may be indicated by the AP); and (c) the 20/40/80/60 MHz channel occupied by the PPDU is identified by the STA, based on the bandwidth field in the PHY preamble of the PPDU and the channel allocations in the corresponding band, and the channel occupied by the PPDU does not overlap with the NPCA primary channel.

Additionally, or alternatively, the AP and NPCA capable non-AP STAs of the BSS may switch to the NPCA primary when the STA receives a PPDU including a control frame exchange on the BSS primary channel and all of the following conditions apply: (a) the received PPDU(s) are classified by the STA as inter-BSS PPDU(s) (e.g., following the procedure defined in 26.2.2 for intra-BSS and inter-BSS PPDU classification); (b) the TXOP duration, determined from the duration field of the received frame(s), is greater than the value indicated in the most recently received or transmitted NPCA minimum duration threshold field corresponding to the BSS of the STA (the RXVECTOR parameter TXOP_DURATION of the received PPDU(s) may be considered for this comparison); and (c) the 20/40/80/60 MHz channel occupied by the received PPDU(s), identified by the STA based on the channel allocations in the corresponding band and the PPDU bandwidth that is signaled in the received PPDU(s) or obtained from the RXVECTOR parameter CH_BANDWIDTH_IN_NON_HT of the received PPDU(s), does not overlap with the NPCA primary channel (if the control frame is a request to send (RTS) frame in a non-HT (duplicate) PPDU, then it includes a bandwidth signaling TA and the signaled PPDU bandwidth is 20 MHz, 40 MHz, 80 MHz, or 160 MHz and identification of the channel occupied by a received CTS frame in a non-HT (duplicate) PPDU is determined by examining the RTS frame or the MU-RTS frame that elicited the CTS response).

In other words, for some NPCA designs, the conditions used for determining whether a STA may switch to an NPCA primary channel depend upon the classification of received PPDUs as inter-BSS PPDUs (e.g., rather than intra-PPDUs). Condition for intra-BSS PPDUs and inter-BSS PPDUs may be defined by one or more IEEE 802.11 standards. For example, in accordance with some such standards, a STA may classify a received PPDU as an inter-BSS PPDU if at least one of the following conditions is true: (a) the BSS color is not disabled and the RXVECTOR parameter BSS_COLOR is not 0 and is not the BSS color of the BSS of which the STA is a member; (b) the PPDU is a very high throughput (VHT) PPDU with RXVECTOR parameter PARTIAL_AID not equal to the BSSID of the BSS in which the STA is associated or any of the other BSSs in the same multiple BSSID set or co-hosted BSSID set to which its BSS belongs and the RXVECTOR parameter GROUP_ID is 0; (c) the PPDU is a VHT PPDU with RXVECTOR parameter PARTIAL_AID not equal to the 4 least significant bits (LSBs) of the BSS color announced by the BSS of which the STA whose dot11ParticalBSSColorImplemented parameter is equal to true is a member and RXVECTOR parameter GROUP_ID equal to 63 when the partial BSS color field in the most recent high efficiency (HE) operation element is 1; (d) the PPDU is either a VHT MU PPDU or an HE MU PPDU with the RXVECTOR parameter UPLINK_FLAG equal to 0, and the STA is an AP; (e) the PPDU carries a frame that has a BSSID field, the value of which is not the BSSID of the BSS in which the STA is associated or any of the other BSSs in the same multiple BSSID set or co-hosted BSSID set to which its BSS belongs or the wildcard BSSID; (f) the PPDU carries a frame that does not have a BSSID field but has both a receiver address (RA) field and transmitter address (TA) field, neither value of which is equal to the BSSID of the BSS in which the STA is associated or any of the other BSSs in the same multiple BSSID set or co-hosted BSSID set to which its BSS belongs (the individual/group bit in the TA field is forced to 0 prior to comparison).

In such NPCA designs, however, the set of conditions defined for NPCA channel switching may be problematic for a BSS in which the AP has enabled NPCA and in which the AP is using a multi-AP coordination scheme (e.g., any of the multi-AP coordination schemes).

For example, as described above, reception of an inter-BSS PPDU on the primary channel may trigger the AP and/or the non-AP STAs of such a BSS to switch to the NPCA primary channel. In other words, reception of an inter-BSS PPDU on the primary channel triggers both the AP and the non-AP STAs of such a BSS to consider switching to the NPCA primary channel. In some cases, however, such a switch may lead to inefficient use of resources. For example, the inter-PPDU may be from another BSS with which the AP has agreed to use one or more multi-AP coordination schemes. In such an example, the AP and/or the non-AP STAs may use a shared TXOP in accordance with the one or more multi-AP coordination schemes rather than switching to the NPCA primary channel. That is, if a sharing AP offers a shared AP an opportunity to use its TXOP with one of the multi-AP coordination schemes, the shared AP and the associated non-AP STAs in the BSS of the AP may (e.g., should) at least consider the offer instead of switching to the NPCA primary channel. Thus, for NPCA designs in which the conditions defined for NPCA channel switching rely on inter-BSS PPDUs, simultaneous use of NPCA and one or more multi-AP coordination may be inefficient. In other words, NPCA design rules in which all inter-BSS PPDUs are equal may cause the use of multi-AP coordination schemes with an NPCA enabled BSS to be inefficient (and thus undesirable for wireless communication networks).

Various aspects of the present disclosure provide a framework for simultaneous use of NPCA and multi-AP coordination schemes. For example, the framework may provide a means for a STA (e.g., an NPCA AP STA or an NPCA non-AP STA) which belongs to an NPCA enabled BSS to determine whether a received PPDU is from a different BSS with which the NPCA enabled BSS has no multi-AP coordination agreement in place and/or no multi-AP coordination scheme in use, or is from a different BSS with which the NPCA enabled BSS has multi-AP coordination agreement in place and/or with which the AP of the NPCA enabled BSS uses one or more of the multi-AP coordination schemes.

In accordance with the framework, and based on the results of the determination, if the PPDU is from the AP (or the BSS) with which the NPCA enabled BSS has no multi-AP coordination agreement in place and/or no multi-AP coordination scheme in use, the STA may directly proceed to consider switching to the NPCA primary channel. Alternatively, if the PPDU is from the AP (or the BSS) with which the NPCA enabled BSS has a multi-AP coordination agreement in place and at least one multi-AP coordination scheme in use, the STA may perform one or more actions according to the multi-AP coordination scheme. That is, the STA acts according to the rules specified for the multi-AP coordination scheme applied to the TXOP. IN some examples, after performing the action(s) according to the multi-AP coordination scheme, the STA may switch to the NPCA primary channel.

In some examples, the framework provides for a PPDU classification, which STAs may use to determine whether a received PPDU is from a BSS with which multi-AP coordination is used. For example, in accordance with the framework, a STA may receive a PPDU or a primitive associated with the PPDU from another STA. For example, the AP 210-a or the client 215-a of BSS1 may receive a PPDU or a primitive associated with the PPDU from another STA of another BSS (e.g., from a STA in BSS2 or BSS3). The primitive may be an example of a PHY-RXSTART.indication primitive for a HE PPDU, an extremely high throughput (EHT) PPDU, or an ultra high reliability (UHR) PPDU.

In response to receiving the PPDU or the primitive, the STA may classify the PPDU based on information included in the PPDU or the primitive. The STA may use the PPDU classification to determine whether the received PPDU is from a BSS with which multi-AP coordination is used. For example, the classification of the PPDU may include selecting (e.g., determining, assigning) a PPDU class for the PPDU from among multiple PPDU classes pertaining to multi-AP coordination with the BSS of the STA (e.g., BSS1). In some examples, the PPDU classification may be in addition to (or instead of) the classification defined for an inter-BSS PPDU class and an intra-BSS PPDU class. For example, in addition to the classification defined for an inter-BSS PPDU class and an intra-BSS PPDU class, another PPDU classification may be defined for a multi-AP coordination (MAPC) PPDU class and a non-MAPC PPDU class. In such an example, in addition to (or instead of) classifying PPDUs as inter-BSS PPDUs or intra-BSS PPDUs, the STA may be configured to classify PPDUs as MAPC PPDUs or non-MAPC PPDUs. The MAPC PPDU class represents PPDUs a STA (e.g., an NPCA capable STA) receives from another BSS with which the BSS of the STA has a multi-AP coordination agreement and/or at least one multi-AP coordination scheme in use. The non-MAPC PPDU class represents PPDUs a STA (e.g., an NPCA capable STA) receives from another BSS with which the BSS of the STA has no multi-AP coordination agreement or no multi-AP coordination scheme in use. As used herein, the term “NPCA capable STA,” and the like, refers to a STA with one or more capabilities to support one or more NPCA operations.

In some examples, whenever an NPCA STA (e.g., an AP STA or non-AP STA) has received a PPDU and/or received a primitive associated with the PPDU on the BSS primary channel, the NPCA STA classifies the PPDU as a MAPC PPDU or a non-MAPC PPDU. For example, AP 210-a and client 215-a may be examples of NPCA capable STAs. In such an example, whenever AP 210-a and/or client 215-a receives a PPDU or a primitive associated with the PPDU on a primary channel of BSS1, AP 210-a and/or client 215-a may classify the PPDU as a MAPC PPDU or a non-MAPC PPDU.

In some examples, the NPCA STA may classify the PPDU as a MAPC PPDU when at least one of a first set of conditions is true. The first set of conditions may include that the PPDU or the primitive carries a frame that has a BSSID field indicating a BSSID (or that the PPDU or the primitive is otherwise indicative of a BSSID). Additionally, or alternatively, the first set of conditions may include that the value of the BSSID field corresponds to the BSSID of one of the BSSs with which the BSS of the NPCA STA has a multi-AP coordination agreement and/or at least one multi-AP coordination scheme in use. For example, the PPDU or the primitive may indicate a BSSID associated with the PPDU. In such an example, the NPCA STA may select the MAPC PPDU class (e.g., from among the MAPC PPDU class and the non-MAPC PPDU class) for the PPDU based on the BSSID corresponding to one of a set of BSSs with which the BSS has a multi-AP coordination agreement or based on the BSSID corresponding to one of a set of BSSs with which the BSS has at least one active multi-AP coordination scheme. In the example of FIG. 2A, AP 210-a and/or client 215-a may receive a PPDU or a primitive from BSS2, and the PPDU or the primitive may be indicative of a BSSID corresponding to BSS2. In such an example, the NPCA STA may select the MAPC PPDU class for the PPDU based on BSS2 being one of a set of BSSs with which BSS1 has a multi-AP coordination agreement or based on BSS2 being one of a set of BSSs with which BSS1 has at least one active multi-AP coordination scheme. As used herein, an active multi-AP coordination scheme refers to a multi-AP coordination scheme that is in use. Additionally, as used herein, a set of BSSs may include one or more BSSs.

In some examples, the first set of conditions may include that the PPDU or the primitive carries a BSS color parameter field indicating a value of a BSS color (or that the PPDU or the primitive is otherwise indicative of a BSS color). Additionally, or alternatively, the first set of conditions may include that the BSS color parameter (e.g., an RXVECTOR parameter BSS_COLOR) indicates the BSS color of one of the BSSs with which the BSS of the NPCA STA has a multi-AP coordination agreement and/or at least one multi-AP coordination scheme in use. For example, the PPDU or the primitive may indicate a BSS color associated with the PPDU. In such an example, the NPCA STA may select the MAPC PPDU class (e.g., from among the MAPC PPDU class and the non-MAPC PPDU class) for the PPDU based on the BSS color being associated with one of a set of BSSs with which the BSS has a multi-AP coordination agreement, based on the BSS color being associated with one of a set of BSSs with which the BSS has at least one active multi-AP coordination scheme, and/or based on the BSS color being associated with the BSS. In the example of FIG. 2A, AP 210-a and/or client 215-a may receive a PPDU or a primitive from BSS2, and the PPDU or the primitive may be indicative of a BSS color associated with BSS2. In such an example, the NPCA STA may select the MAPC PPDU class for the PPDU based on BSS2 being one of a set of BSSs with which the BSS has a multi-AP coordination agreement or based BSS2 being one of a set of BSSs with which the BSS has at least one active multi-AP coordination scheme. Additionally, or alternatively, the NPCA STA may select the MAPC PPDU class for the PPDU based on the BSS color being associated with BSS1. For example, two BSSs that have a multi-AP coordination agreement and/or at least one multi-AP coordination scheme in use may operate with a common BSS color. In such an example, the NPCA STA may select the MAPC PPDU class for the PPDU based on the BSS color being common to both BSS1 and BSS2.

In some examples, the NPCA STA may classify the PPDU as a non-MAPC PPDU when at least one of a second set of conditions is true. The second set of conditions may include that the PPDU or the primitive does not carry a frame that has a BSSID field indicating a BSSID (or that the PPDU or the primitive is not otherwise indicative of a BSSID). Alternatively, the second set of conditions may include that the PPDU or the primitive does carry a frame that has a BSSID field indicating a BSSID (or that the PPDU or the primitive is otherwise indicative of a BSSID), and that the value of the BSSID field corresponds to a BSSID of a BSS that is not one of the BSSs with which the BSS of the NPCA STA has a multi-AP coordination agreement and/or at least one multi-AP coordination scheme in use. For example, the PPDU or the primitive may indicate a BSSID associated with the PPDU. In such an example, the NPCA STA may select the non-MAPC PPDU class (e.g., from among the MAPC PPDU class and the non-MAPC PPDU class) for the PPDU based on the BSSID corresponding to a BSS outside of a set of BSSs with which the BSS has a multi-AP coordination agreement or based on the BSSID corresponding to a BSS outside of a set of BSSs with which the BSS has at least one active multi-AP coordination scheme. In the example of FIG. 2A, AP 210-a and/or client 215-a may receive a PPDU or a primitive from BSS3, and the PPDU or the primitive may be indicative of a BSSID corresponding to BSS3. In such an example, the NPCA STA may select the MAPC PPDU class for the PPDU based on BSS3 having no multi-AP coordination agreement with BSS1 or based on BSS3 and BSS1 having no active multi-AP coordination scheme in use.

In some examples, the second set of conditions may include that the PPDU or the primitive does not carry a BSS color parameter field indicating a value of a BSS color (or that the PPDU or the primitive is not otherwise indicative of a BSS color). Additionally, or alternatively, the second set of conditions may include that the BSS color parameter (e.g., an RXVECTOR parameter BSS_COLOR) indicates the BSS color of a BSS that is not one of the BSSs with which the BSS of the NPCA STA has a multi-AP coordination agreement and/or at least one multi-AP coordination scheme in use. For example, the PPDU or the primitive may indicate a BSS color associated with the PPDU. In such an example, the NPCA STA may select the non-MAPC PPDU class (e.g., from among the MAPC PPDU class and the non-MAPC PPDU class) for the PPDU based on the BSS color being associated with a BSS outside of a set of BSSs with which the BSS has a multi-AP coordination agreement, based on the BSS color being associated with a BS outside of a set of BSSs with which the BSS has at least one active multi-AP coordination scheme, and/or based on the BSS color being different from another BSS color associated with the BSS. In the example of FIG. 2A, AP 210-a and/or client 215-a may receive a PPDU or a primitive from BSS3, and the PPDU or the primitive may be indicative of a BSS color associated with BSS3. In such an example, the NPCA STA may select the non-MAPC PPDU class for the PPDU based on BSS3 having no multi-AP coordination agreement with BSS1 or based BSS3 and BSS1 having no active multi-AP coordination scheme. Additionally, or alternatively, the NPCA STA may select the non-MAPC PPDU class for the PPDU based on the BSS color being different from another BSS color associated with BSS1 (e.g., based on BSS3 and BSS1 having different BSS colors). By configuring the STA to classify received PPDUs as MAPC PPDUs and non-MAPC PPDUs, the STA may improve resource utilization and reduce latency within the communications system 200.

In some examples, the framework provides for one or more actions by a STA upon the PPDU classification. For example, in accordance with the framework, the STA may receive a PPDU or a primitive associated with the PPDU on a primary channel of a first BSS (e.g., BSS1) associated with the STA. In some such examples, the PPDU or the primitive may be received from a second BSS (e.g., BSS2 or BSS3). In response to receiving the PPDU or the primitive, the STA may perform one or more operations based on a PPDU class associated with the PPDU, in which the PPDU class pertains to multi-AP coordination between the first BSS and the second BSS. In other words, the STA may perform one or more actions upon classification of the PPDU as a MAPC PPDU or a non-MAPC PPD. In some examples, the NPCA STA may switch to the NPCA primary channel for NPCA operation (e.g., without any actions related to a multi-AP coordination scheme) based on the PPDU class. For example, the NPCA STA may switch to the NPCA primary channel for NPCA operation (e.g., without any actions related to a multi-AP coordination scheme), if the PPDU is classified as a non-MAPC PPDU. That is, the NPCA STA may switch to the NPCA primary channel based on the PPDU class being a non-MAPC PPDU class representative of PPDUs which a STA of a BSS receives from another BSS with which the BSS has no multi-AP coordination agreement or no multi-AP coordination scheme in use.

In some other examples, the STA may perform one or more operations associated with a multi-AP coordination scheme based on the PPDU class. In some such examples, the STA may perform the one or more operations in accordance with multi-AP coordination agreement between the first BSS and the second BSS. For example, the NPCA STA may take one or more actions related to a multi-AP coordination scheme, if the PPDU is classified as a MAPC PPDU. That is, the STA may perform one or more operations associated with a multi-AP coordination scheme based on the PPDU class comprising a MAPC PPDU class representative of PPDUs which a STA of a BSS receives from another BSS with which the BSS has a multi-AP coordination agreement and at least one multi-AP coordination scheme in use. In some examples, after performing the one or more actions (e.g., only after those actions), the NPCA STA may switch to the NPCA primary channel for NPCA operation. That is, the STA may switch from the primary channel of the first BSS to an NPCA primary channel for NPCA operations after completion of the one or more operations. By configuring the STA to perform one or more actions based on the PPDU class, the STA may improve resource utilization and reduce latency within the communications system 200.

In some examples, the framework provides means for information that a STA (e.g., each STA) uses for PPDU classification to be made available. For example, in accordance with the framework, a non-AP STA may receive a message including information associated with one or more multi-AP coordination relationships between a first BSS including the non-AP STA and one or more other BSSs. In such an example, the non-AP STA may receive a PPDU or a primitive associated with the PPDU on a primary channel of the first BSS. In response to receiving the PPDU or the primitive, the non-AP STA may determine a PPDU class for the PPDU based on the information.

For example, when an AP has established a multi-AP coordination relationship with another AP (e.g., by using one or more procedures/protocols specified in 802.11bn, including the MAPC negotiation), the AP notifies one or more non-AP STAs connected to the AP about the established relationship. The notification includes information for use by the non-AP STA(s) when receiving a PPDU to implement PPDU classification. In some examples, such as when there is a change in a multi-AP agreement or relationship the AP as with another AP (e.g., whenever there are any changes in any of the multi-AP coordination agreements or relationships that an AP has with other APs), the AP may notify the non-AP STA(s) connected to the AP of the changes. For example, the non-AP STA may receive a second message including second information associated with the one or more multi-AP coordination relationships, and the second information may indicate the change to the one or more multi-AP coordination relationships.

In some examples, the notification may include (or otherwise indicate) a BSSID and/or BSS color of the other AP. Additionally, or alternatively, the notification may include (or otherwise indicate) a state/status of an MAPC negotiation and/or a list of multi-AP coordination schemes negotiated for use between the two APs. For example, wherein the information (or the second information) may include at least one of the following: at least one BSSID associated with the one or more other BSSs, at least one BSS color associated with the one or more other BSSs, a status of at least one MAPC negotiation with the one or more other BSSs, or at least one coordination scheme negotiated for use between the first BSS and the one or more other BSSs. In some examples, the notification may be embedded into an association response frame and/or beacon frame. That is, the non-AP STA may receive an association response frame or beacon frame including the information. Alternatively, an action frame based protocol may be used to carry such notifications. Such action frames may be transmitted in a unicast, multicast and/or broadcast manner. That is, the STA may receive an action frame including the information, where the action frame is unicast action, multicast, or broadcast from an AP. By providing non-AP STA(s) with multi-AP coordination relationship information, the AP may enable the non-AP STA(s) to perform PPDU classification, which may improve resource utilization and reduce latency within the communications system 200.

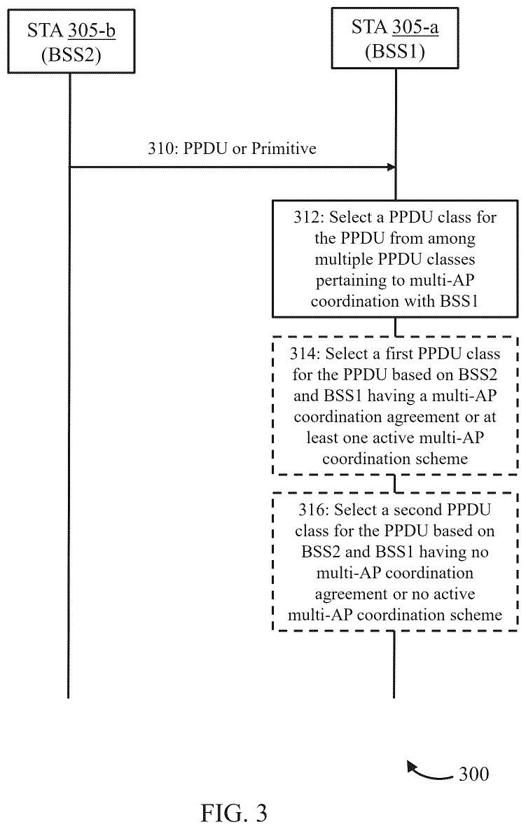

FIG. 3 illustrates an example signaling diagram 300 to which one or more examples disclosed herein may be applied. The signaling diagram 300 illustrates operations performed, such as within the system of FIG. 1 or 2A, by a STA 305-a and a STA 305-b in accordance with one or more aspects of the present disclosure. The STAs 305 may be examples of an AP or a client (e.g., non-AP STA) illustrated by and described with reference to FIGS. 1, 2A, 2B, and 2C. For example, one or more of the STAs 305 may be capable of performing one or more NPCA operations. One or more operations performed at the STAs 305 may be performed in a different order than the example order shown. Additionally, or alternatively, one or more operations performed at the STAs 305 may be omitted and/or one or more other operations may be added. The signaling diagram 300 may support a framework for simultaneous use of NPCA and multi-AP coordination as described herein.

At 310, the STA 305-a receives a PPDU or a primitive associated with the PPDU from STA 305-b. The PPDU may be an HE PPDU, an EHT PPDU, or a UHR PPDU. The primitive may be associated with the PPDU by being indicative of an incoming frame carried in the PPDU. For example, the primitive may be a PHY-RXSTART.indication primitive associated with the HE/EHT/UHR PPDU. In some examples, the STA 305-a may receive the PPDU or the primitive on a primary channel of BSS1.

The STA 305-a may classify the PPDU based on information included in the PPDU or the primitive. For example, the STA 305-a may be configured to support classification of PPDUs into a MAPC PPDU class or a non-MAPC PPDU. The MAPC PPDU class represents PPDUs an NPCA STA receives from another BSS with which the BSS of the NPCA STA has a multi-AP coordination agreement and/or at least one multi-AP coordination scheme in use. The non-MAPC PPDU class represents PPDUs an NPCA STA receives from another BSS with which the BSS of the NPCA STA has no multi-AP coordination agreement or no multi-AP coordination scheme in use. In such an example, whenever an NPCA STA (an AP STA or non-AP STA) has received a PPDU and/or a PHY-RXSTART.indication primitive for an HE/EHT/UHR PPDU on the BSS primary channel, the NPCA STA classifies the PPDU as a MAPC PPDU based on one or more first criteria being satisfied or classifies the PPDU as a non-MAPC PPDU based on one or more second criteria being satisfied. In some examples, the STA 305-a may use information included in the PPDU or primitive to determine whether the one or more first criteria or the one or more second criteria are satisfied. The information may include (or be indicative of) a BSS ID and/or a BSS color.

At 312 in accordance with the classification, the STA 305-a selects a PPDU class for the PPDU from among multiple PPDU classes pertaining to multi-AP coordination with BSS1. For example, in accordance with the classification, the STA 305-a may be configured to select a first PPDU class (e.g., the MAPC PPDU class) of the multiple PPDU classes based on the PPDU or the primitive being received from a BSS with which the first BSS has a multi-AP coordination agreement or at least one active multi-AP coordination scheme. Additionally, in accordance with the classification, the STA 305-a may be configured to select a second PPDU class (e.g., the non-MAPC PPDU class) of the multiple PPDU classes based on the PPDU or the primitive being received from a BSS with which the first BSS has no multi-AP coordination agreement or no active multi-AP coordination scheme.

For example, at 314, the STA 305-a may select the first PPDU class (e.g., the MAPC PPDU class) for the PPDU based on BSS2 and BSS1 having a multi-AP coordination agreement or at least one active multi-AP coordination scheme. In some examples, the PPDU or the primitive carries a frame that has a BSS ID field indicating a value of a BSS ID (e.g., a BSSID associated with BSS2). In some such examples, the STA 305-a may select the first PPDU class based on the BSS ID corresponding to one of a set of BSSs with which BSS1 has a multi-AP coordination agreement and/or based on the BSS ID corresponds to one of a set of BSSs with which BSS1 has at least one active multi-AP coordination scheme. Additionally, or alternatively, in some examples, the PPDU or the primitive carries a BSS color parameter field indicating a value of a BSS color (e.g., a BSS color associated with BSS2). In some such examples, the STA 305-a may select the first PPDU class based on the BSS color being associated with one of a set of BSSs with which BSS1 has a multi-AP coordination agreement, based on the BSS color being associated with one of a set of BSSs with which BSS1 has at least one active multi-AP coordination scheme, and/or based on the BSS color being associated with BSS1 (e.g., being common to BSS1 and BSS2).

Alternatively, at 316, the STA 305-a may select the second PPDU class (e.g., the non-MAPC PPDU class) for the PPDU based on BSS2 and BSS1 having no multi-AP coordination agreement or no active multi-AP coordination scheme. In some examples, the PPDU or the primitive carries a frame that has a BSS ID field indicating a value of a BSS ID (e.g., a BSSID associated with BSS2). In some such examples, the STA 305-a may select the second PPDU class based on the BSS ID corresponding to a BSS outside of a set of BSSs with which BSS1 has a multi-AP coordination agreement and/or based on the BSS ID corresponding to a BSS outside of a set of BSSs with which BSS1 has at least one active multi-AP coordination scheme. Additionally, or alternatively, in some examples, the PPDU or the primitive carries a BSS color parameter field indicating a value of a BSS color (e.g., a BSS color associated with BSS2). In some such examples, the STA 305-a may select the second PPDU class based on the BSS color being associated with a BSS outside of a set of BSSs with which BSS1 has a multi-AP coordination agreement, the BSS color being associated with a BSS outside of a set of BSSs with which BSS1 has at least one active multi-AP coordination scheme, and/or the BSS color being different from another BSS color associated with BSS1 (e.g., based on BSS1 and BSS2 having different BSS colors). By classifying received PPDUs as MAPC PPDUs and non-MAPC PPDUs, the STA 305-a may improve resource utilization and reduce latency within the system.

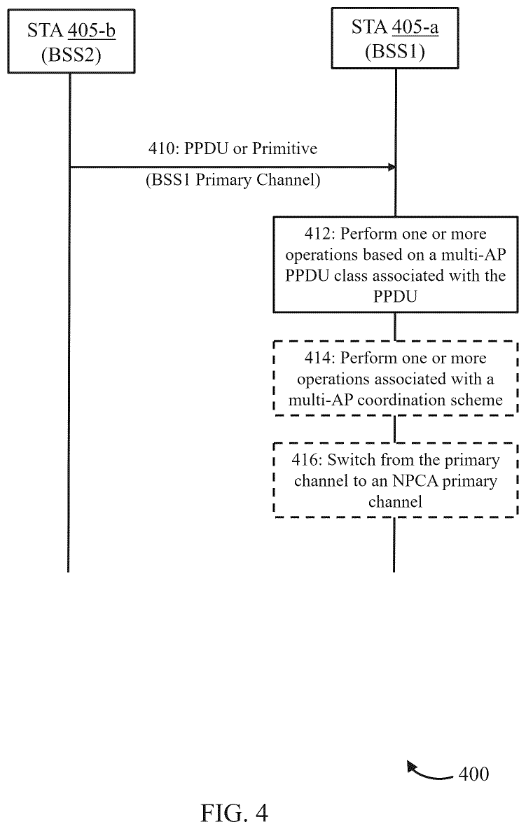

FIG. 4 illustrates an example signaling diagram 400 to which one or more examples disclosed herein may be applied. The signaling diagram 400 illustrates operations performed, such as within the system of FIG. 1 or 2A, by a STA 405-a and a STA 405-b in accordance with one or more aspects of the present disclosure. The STAs 405 may be examples of an AP or a client (e.g., non-AP STA) illustrated by and described with reference to FIGS. 1, 2A, 2B, 2C, and 3. For example, one or more of the STAs 405 may be capable of performing one or more NPCA operations. One or more operations performed at the STAs 405 may be performed in a different order than the example order shown. Additionally, or alternatively, one or more operations performed at the STAs 405 may be omitted and/or one or more other operations may be added. The signaling diagram 400 may support a framework for simultaneous use of NPCA and multi-AP coordination as described herein.

At 410, the STA 405-a receives a PPDU or a primitive associated with the PPDU from STA 405-b. The PPDU may be an HE PPDU, an EHT PPDU, or a UHR PPDU. The primitive may be associated with the PPDU by being indicative of an incoming frame carried in the PPDU. For example, the primitive may be a PHY-RXSTART.indication primitive associated with the HE/EHT/UHR PPDU. In some examples, the STA 405-a may receive the PPDU or the primitive on a primary channel of BSS1.

At 412, the STA 405-a may perform one or more operations based on a multi-AP PPDU class associated with the PPDU. For example, the STA 405-a may perform one or more operations based on a PPDU class associated with the PPDU, where the PPDU class pertains to multi-AP coordination between BSS1 and BSS2. In some examples, the STA 405-a may determine the PPDU class associated with the PPDU. For example, the STA 405-a may be configured to support PPDU classification as illustrated by and described with reference to FIG. 3.

In some examples, the one or more operations may include the STA 405-a switching to an NPCA primary channel or NPCA operation. For example, an NPCA STA may be configured to switch to the NPCA primary channel for NPCA operation based on the PPDU class being a non-MAPC PPDU class. In such an example, based on the PPDU class being the non-MAPC PPDU class, the NPCA STA may switch to the NPCA primary channel for NPCA operation without any actions related to a multi-AP coordination scheme. In other words, the NPCA STA may refrain from performing one or more operations associated with a multi-AP coordination scheme (e.g., may skip 414) based on the PPDU class being the non-MAPC PPDU class.

For example, at 416, the STA 405-a may switch from the primary channel of BSS1 to the NPCA primary channel for NPCA operations based on the PPDU class. In such an example, the STA 405-a may switch to the NPCA primary channel based on the PPDU class being the non-MAPC PPDU class representative of PPDUs, which a STA of a BSS receives from another BSS with which the BSS has no multi-AP coordination agreement or no multi-AP coordination scheme in use.

In some other examples, the one or more operations may include one or more operations of a multi-AP coordination scheme. For example, an NPCA STA may take actions related to a multi-AP coordination scheme based on the PPDU class being a MAPC PPDU class. In some examples, after performing those actions, the NPCA STA may switch to the NPCA primary channel for NPCA operation.

For example, at 414, the STA 405-a may perform the one or more operations associated with the multi-AP coordination scheme. In such an example, the STA 405-a may perform the one or more operations in accordance with a multi-AP coordination agreement between BSS1 and BSS2. In some examples, the STA 405-a may switch from the primary channel to the NPCA primary channel (at 416) for NPCA operations after completion of the one or more operations at 414. By performing one or more actions based on the PPDU class, the STA 405-a may improve resource utilization and reduce latency within the system.

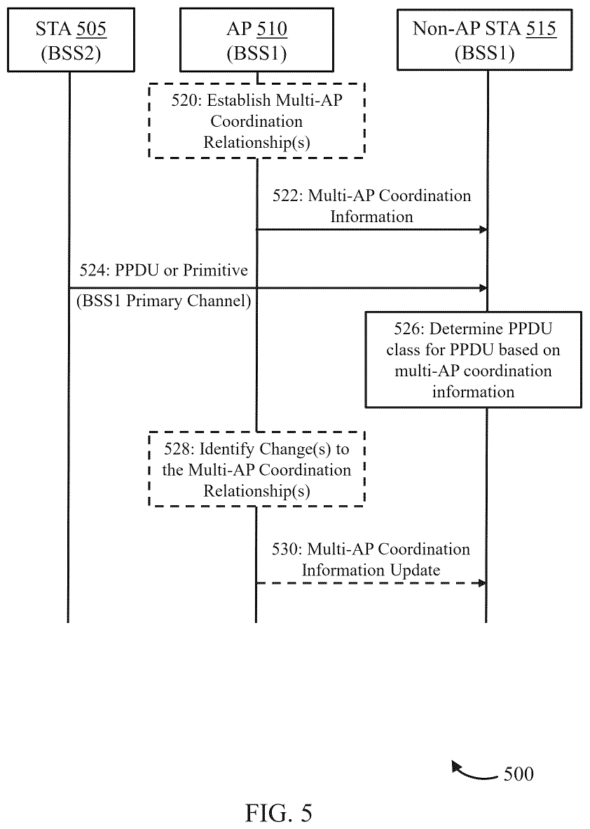

FIG. 5 illustrates an example signaling diagram 500 to which one or more examples disclosed herein may be applied. The signaling diagram 500 illustrates operations performed, such as within the system of FIG. 1 or 2A, by a STA 505, an AP 510, and a non-AP STA 515 in accordance with one or more aspects of the present disclosure. The STA 505 may be an example of an AP or a non-AP STA illustrated by and described with reference to FIGS. 1, 2A, 2B, 2C, 3, and 4. Additionally, the AP 510 and the non-AP STA 515 (e.g., a client) may be examples of the corresponding devices illustrated by and described with reference to FIGS. 1, 2A, 2B, 2C, 3, and 4. One or more operations performed at the STA 505, the AP 510, and the non-AP STA 515 may be performed in a different order than the example order shown. Additionally, or alternatively, one or more operations performed at the STA 505, the AP 510, and the non-AP STA 515 may be omitted and/or one or more other operations may be added. The signaling diagram 500 may support a framework for simultaneous use of NPCA and multi-AP coordination as described herein.

In some examples, at 520, the AP 510 establishes one or more one or more multi-AP coordination relationships between BSS1 and one or more other BSSs. In some such examples, the AP 510 may notify the non-AP STA 515 of the established multi-AP coordination relationships. For example, when an AP has established a multi-AP coordination relationship with another AP (e.g., by using the 802.11bn specified procedures and protocols including the MAPC negotiation), the AP notifies non-AP STAs connected to the AP about the relationship. The notification may include information for use by the non-AP STAs when receiving a PPDU to implement PPDU classification.

At 522, the non-AP STA 515 receives multi-AP coordination information from the AP 510. For example, the non-AP STA 515 may receive a message including information associated with one or more multi-AP coordination relationships between BSS1 and one or more other BSSs. The multi-AP coordination information may be used by the non-AP STA 515 for PPDU classification. For example, the information may include at least one of the following: at least one BSS ID associated with the one or more other BSSs, at least one BSS color associated with the one or more other BSSs, a status of at least one MAPC negotiation with the one or more other BSSs, or at least one coordination scheme negotiated for use between the first BSS and the one or more other BSSs.

At 524, the non-AP STA 515 receives a PPDU or a primitive associated with the PPDU on a primary channel of BSS1 from the STA 505. The PPDU may be an HE PPDU, an EHT PPDU, or a UHR PPDU. The primitive may be associated with the PPDU by being indicative of an incoming frame carried in the PPDU. For example, the primitive may be a PHY RXSTART.indication primitive associated with the HE/EHT/UHR PPDU.

At 526, the non-AP STA 515 determines a PPDU class for the PPDU based on the information. For example, the STA 405-a may be configured to support PPDU classification as illustrated by and described with reference to FIG. 3.

In some examples, at 528, the AP 510 may identify a change to the one or more multi-AP coordination relationships. For example, the AP 510 may end or modify an existing multi-AP coordination relationship. Additionally, or alternatively, the AP 510 may establish a new multi-AP coordination relationship.

In some such examples, at 530, the non-AP STA 515 may receive a multi-AP coordination information update from the AP 510. For example, when the AP 510 identifies a change to a multi-AP coordination agreement or relationship (e.g., a respective one or more changes to one or more of the multi-AP coordination agreements or relationships) that the AP 510 has with other APs, the AP 510 may notify the non-AP STA 515 of the change(s). In some examples, the non-AP STA 515 may receive a second message including second information associated with the one or more multi-AP coordination relationships. The second information may indicate the change(s) to the one or more multi-AP coordination relationships. For example, the second information may be updated relative to the information to reflect the change(s). In some examples, the non-AP STA 515 may receive the information (or the second information) via an association response frame or beacon frame. In some other examples, the non-AP STA 515 may receive the information (or the second information) via an action frame, which may be unicast, multicast, or broadcast from the AP 510. By providing the non-AP STA 515 with the multi-AP coordination relationship information, the AP 510 may enable the non-AP STA 515 to perform PPDU classification, which may improve resource utilization and reduce latency within the system.

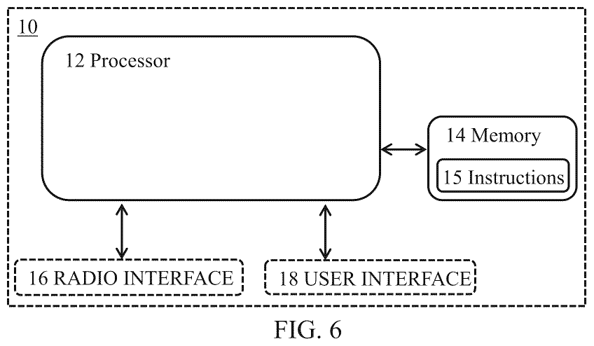

FIG. 6 illustrates an example block diagram of an apparatus 10 to which one or more examples disclosed herein may be applied. The apparatus 10 comprises, for example, at least one processor 12 and at least one memory 14 storing instructions 15 that, when executed by the at least one processor, cause the apparatus 10 at least to perform one or more methods as disclosed herein, and any of the embodiments thereof. In an example, the at least one memory and the instructions (e.g. a computer program code, software), are configured, with the at least one processor, to cause the apparatus 10 to perform one or more methods as disclosed herein, and any of the embodiments thereof.

A processor 12 may comprise circuitry, or be constituted as circuitry or circuitries, the circuitry or circuitries being configured to perform phases of methods in accordance with one or more example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 10 but accessible to apparatus 10.

The instructions 15 may be comprised in a computer readable medium or a non-transitory computer readable medium. A term non-transitory, as used herein, is a limitation of the medium itself (e.g., tangible, not a signal) as opposed to a limitation on data storage persistency (e.g. random access memory, RAM, vs. read only memory, ROM).

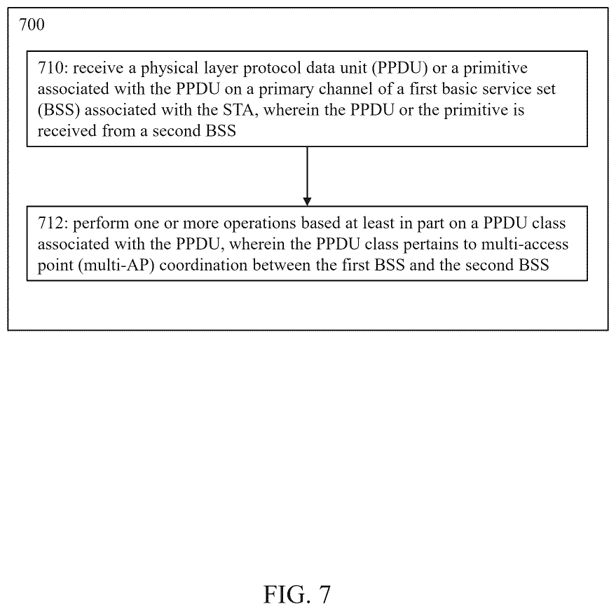

For example, the apparatus 10 may be an AP, such as an AP of FIGS. 1, 2A, 2B, 2C, 3, 4, and 5. As another example, the apparatus may be comprised in such an AP, e.g. as a chipset configured to control the AP. The apparatus 10 may be caused or configured to perform at least the method of FIG. 7 and/or any one or more of the embodiments described.

As another example, the apparatus 10 may be a non-AP STA of FIGS. 1, 2A, 2B, 2C, 3, 4, and 5. In another example, the apparatus may be comprised in such a STA, e.g. as a chipset configured to control the STA. The apparatus 10 may be caused or configured to perform at least the methods of FIG. 7 and/or any one or more of the embodiments described. In some examples, the apparatus 10 may be a UE, or another type of terminal device.

The apparatus may comprise one or more entities of any of protocol layers, such as a MAC entity, a radio resource control (RRC) entity, a radio link control (RLC) entity, a packet data convergence protocol (PDCP) entity or a PHY entity. In at least one embodiment, the entity is configured to perform at least the methods of FIG. 7 and/or any one or more of the embodiments described herein.

In some examples, the apparatus 10 may include a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise a user interface 18 comprising, for example, at least one of a keypad, a microphone, a touch display, a display, a speaker, etc. The user interface 18 may be used to control the apparatus by the user. The user interface 18 may be external to the apparatus 10. For example, the apparatus 10 may be connected to another device, such as a computer, either via wireless or wired connection, and the apparatus 10 is controlled by the user via the computer.

In some examples, the apparatus 10 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The apparatus 10 may also include the at least one processor 12 and/or the at least one memory 14. The at least one processor 12 may be used to execute instructions stored in the at least one memory 14 and/or to store information in the at least one memory 14, for example, such as the results of the executed instructions.

In some examples, the at least one processor 12 may be in communication with the at least one memory 14 via a bus for passing information among components of the apparatus 10. The at least one memory 14 may be non-transitory and may include, for example, one or more volatile and/or non-volatile memories. For example, the at least one memory 14 may be an electronic storage device (e.g., a computer readable storage medium) comprising gates configured to store data (e.g., bits) that may be retrievable by a machine (e.g., a computing device like the processor). The at least one memory 14 may be configured to store information, data, content, applications, instructions, or the like for enabling the apparatus to carry out various functions in accordance with an example embodiment of the present disclosure.

In some examples, the apparatus 10 includes one or more transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver. In some examples, the apparatus 10 is implemented in or by a user device to which resources on an access interface may be allocated and assigned.

In some examples, the apparatus 10 is embodied in a chip or chip set. For example, the apparatus 10 may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 10 may therefore, in some cases, be configured to implement an embodiment of the present disclosure on a single chip or as a single system on a chip (SOC). As such, in some cases, a chip or chipset may constitute means for performing one or more operations for providing the functionalities described herein.

In some examples, the at least one processor 12 may be embodied in a number of different ways. For example, the at least one processor 12 may be implemented by processing circuitry. For example, the at least one processor 12 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC, an FPGA, a microcontroller unit (MCU), a hardware accelerator, a special-purpose computer chip, and/or the like. As such, in some embodiments, the at least one processor 12 may include one or more processing cores configured to perform independently. A multi-core processor may enable multiprocessing within a single physical package. Additionally, or alternatively, the at least one processor 12 may include one or more processors configured in tandem via the bus to enable independent execution of instructions, pipelining and/or multithreading.

In an example embodiment, the at least one processor 12 may be configured to execute instructions stored in the at least one memory 14 or otherwise accessible to the at least one processor 12. Alternatively, or additionally, the at least one processor 12 may be configured to execute hard coded functionality. As such, whether configured by hardware or software methods, or by a combination thereof, the at least one processor 12 may represent an entity (e.g., physically embodied in circuitry) capable of performing operations according to an embodiment of the present disclosure while configured accordingly. Thus, for example, when the at least one processor 12 is embodied as an ASIC, FPGA, and/or the like, the at least one processor 12 may be specifically configured hardware for conducting the operations described herein. Alternatively, or additionally, as another example, when the at least one processor 12 is embodied as an executor of instructions, the instructions may specifically configure the processor to perform the algorithms and/or operations described herein when the instructions are executed. However, in some cases, the at least one processor 12 may be a processor of a specific device (e.g., an image or video processing system) configured to employ an embodiment of the present disclosure by further configuration of the processor by instructions for performing the algorithms and/or operations described herein. The at least one processor 12 may include, among other things, a clock, an arithmetic logic unit (ALU), and/or logic gates configured to support operation of the at least one processor 12.

The radio interface 16 (e.g., a communication interface) may be a device and/or circuitry embodied in either hardware or a combination of hardware and software that is configured to receive and/or transmit data, including media content in the form of video or image files, one or more audio tracks, and/or the like. In this regard, the radio interface 16 may include, for example, an antenna (or multiple antennas) and supporting hardware and/or software for enabling communications with a wireless communication network. Additionally, or alternatively, the radio interface 16 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), USB or other mechanisms.

In some examples, the apparatus 10 may be an AP or a non-AP STA (e.g., such as a client device) usable in a Wi-Fi network capable of operating in accordance with wireless standards (e.g., IEEE 802.11 standards).

In at least one embodiment, at least some of the processes described herein may be carried out by an apparatus comprising means for carrying out at least some of the described processes. Means for performing methods as disclosed herein may include software and/or hardware components of the apparatus 10. For example, the at least one processor 12, the memory 14, and the computer program code form means for carrying out the method or methods as disclosed herein, and any of the embodiments thereof. The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example, performing such functionality or functionalities may be caused in an apparatus by a processor that executes instructions stored in a memory of the apparatus.

FIG. 7 illustrates an example flowchart 700 of a method to which one or more examples disclosed herein may be applied. The method may be computer-implemented. The method may be performed by a device, such as a STA illustrated by and described with reference to 1, 2A, 2B, 2C, 3, 4, and 5. In some examples, the STA may be an example of an apparatus 10 illustrated by and described with reference to FIG. 6.

As shown in FIG. 7, the STA, at block 710, receives a PPDU or a primitive associated with the PPDU on a primary channel of a first BSS associated with the STA, wherein the PPDU or the primitive is received from a second BSS. For example, the STA may include the means (e.g., a processor 12, a memory 14, a radio interface 16) for receiving a PPDU or a primitive associated with the PPDU on a primary channel of a first BSS associated with the STA, wherein the PPDU or the primitive is received from a second BSS.

As shown in FIG. 7, the STA, at block 712, performs one or more operations based at least in part on a PPDU class associated with the PPDU, wherein the PPDU class pertains to multi-AP coordination between the first BSS and the second BSS. For example, the STA may include the means (e.g., a processor 12, a memory 14) for performing one or more operations based at least in part on a PPDU class associated with the PPDU, wherein the PPDU class pertains to multi-AP coordination between the first BSS and the second BSS.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor; and
at least one memory storing instructions that, when executed by the at least one processor, cause the apparatus at least to:
receive a physical layer protocol data unit (PPDU) or a primitive associated with the PPDU on a primary channel of a first basic service set (BSS) associated with the apparatus, wherein the PPDU or the primitive is received from a second BSS; and
perform one or more operations based at least in part on a PPDU class associated with the PPDU, wherein the PPDU class pertains to multi-access point (multi-AP) coordination between the first BSS and the second BSS.

2. An apparatus according to claim 1, wherein performing the one or more operations comprises:
switching from the primary channel to a non-primary channel access (NPCA) primary channel for NPCA operations based at least in part on the PPDU class.

3. An apparatus according to claim 2, wherein switching to the NPCA primary channel is based at least in part on the PPDU class comprising a non-multi-AP coordination (non-MAPC) PPDU class representative of PPDUs which a station (STA) of a BSS receives from another BSS with which the BSS has no multi-AP coordination agreement or no multi-AP coordination scheme in use.

4. An apparatus according to claim 1, wherein the one or more operations are associated with a multi-AP coordination scheme, and wherein the one or more operations are performed in accordance with a multi-AP coordination agreement between the first BSS and the second BSS.

5. An apparatus according to claim 4, wherein the multi-AP coordination scheme comprises one of the following: coordinated beamforming (Co-BF), coordinated spatial reuse (Co-SR), coordinated restricted target wake time (Co-RTWT), or coordinated time division multiple access (Co-TDMA).

6. An apparatus according to claim 4, wherein the instructions, when executed by the at least one processor, cause the apparatus at least to:
switch from the primary channel to a non-primary channel access (NPCA) primary channel for NPCA operations after completion of the one or more operations.

7. An apparatus according to claim 4, wherein performing the one or more operations is based at least in part on the PPDU class comprising a multi-AP coordination (MAPC) PPDU class representative of PPDUs which a station (STA) of a BSS receives from another BSS with which the BSS has a multi-AP coordination agreement and at least one multi-AP coordination scheme in use.

8. An apparatus according to claim 1, wherein the PPDU comprises one of the following: a high efficiency (HE) PPDU, an extremely high throughput (EHT) PPDU, or an ultra high reliability (UHR) PPDU.

9. An apparatus according to claim 1, wherein the primitive is associated with the PPDU by being indicative of an incoming frame carried in the PPDU.

10. An apparatus according to claim 9, wherein the primitive comprises a PHY-RXSTART.indication primitive.

11. An apparatus according to claim 1, wherein the apparatus comprises an AP or non-access point (non-AP) station (STA).

12. An apparatus according to claim 11, wherein the AP or non-AP STA is capable of performing one or more NPCA operations.

13. A method, comprising:
receiving a physical layer protocol data unit (PPDU) or a primitive associated with the PPDU on a primary channel of a first basic service set (BSS) associated with an apparatus, wherein the PPDU or the primitive is received from a second BSS; and
performing one or more operations based at least in part on a PPDU class associated with the PPDU, wherein the PPDU class pertains to multi-access point (multi-AP) coordination between the first BSS and the second BSS.

14. A method according to claim 13, wherein performing the one or more operations comprises:
switching from the primary channel to a non-primary channel access (NPCA) primary channel for NPCA operations based at least in part on the PPDU class.

15. A method according to claim 14, wherein switching to the NPCA primary channel is based at least in part on the PPDU class comprising a non-multi-AP coordination (non-MAPC) PPDU class representative of PPDUs which a station (STA) of a BSS receives from another BSS with which the BSS has no multi-AP coordination agreement or no multi-AP coordination scheme in use.

16. A method according to claim 13, wherein the one or more operations are associated with a multi-AP coordination scheme, and wherein the one or more operations are performed in accordance with a multi-AP coordination agreement between the first BSS and the second BSS.

17. A method according to claim 16, wherein the multi-AP coordination scheme comprises one of the following: coordinated beamforming (Co-BF), coordinated spatial reuse (Co-SR), coordinated restricted target wake time (Co-RTWT), or coordinated time division multiple access (Co-TDMA).

18. A method according to claim 16, further comprising:
switching from the primary channel to a non-primary channel access (NPCA) primary channel for NPCA operations after completion of the one or more operations.

19. A method according to claim 16, wherein performing the one or more operations is based at least in part on the PPDU class comprising a multi-AP coordination (MAPC) PPDU class representative of PPDUs which a station (STA) of a BSS receives from another BSS with which the BSS has a multi-AP coordination agreement and at least one multi-AP coordination scheme in use.

20-24. (canceled)

25. A non-transitory computer readable storage medium comprising instructions that, when executed by an apparatus, cause the apparatus at least to:
receive a physical layer protocol data unit (PPDU) or a primitive associated with the PPDU on a primary channel of a first basic service set (BSS) associated with the apparatus, wherein the PPDU or the primitive is received from a second BSS; and
perform one or more operations based at least in part on a PPDU class associated with the PPDU, wherein the PPDU class pertains to multi-access point (multi-AP) coordination between the first BSS and the second BSS.
